(19) United States
(12) Patent Application Publication
(10) Pub. No.: US 2023/0123472 A1
(43) Pub. Date: Apr. 20, 2023

(54) VISION-AIDED WIRELESS COMMUNICATION SYSTEMS

(71) Applicant: ARIZONA BOARD OF REGENTS ON BEHALF OF ARIZONA STATE UNIVERSITY, Scottsdale, AZ (US)

(72) Inventors: Ahmed ALKHATEEB, Chandler, AZ (US); Muhammed ALRABEIAH, Tempe, AZ (US); Andrew HREDZAK, Chandler, AZ (US)

(73) Assignee: ARIZONA BOARD OF REGENTS ON BEHALF OF ARIZONA STATE UNIVERSITY, Scottsdale, AZ (US)

(21) Appl. No.: 17/906,198

(22) PCT Filed: Mar. 15, 2021
(86) PCT No.: PCT/US2021/022325

§ 371 Date: Sep. 13, 2022

Related U.S. Application Data
(60) Provisional application No. 62/989,179, filed on Mar. 13, 2020.
(60) Provisional application No. 62/989,256, filed on Mar. 13, 2020.

(51) Int. Cl. H04B 7/06; H04W 36/32; H04W 64/00; G01S 13/86

(52) U.S. Cl. CPC H04B 7/0617; H04W 36/32; H04W 64/003; G01S 13/867

(57) ABSTRACT

Vision-aided wireless communications systems are provided. Embodiments disclosed herein leverage visual data sensors (such as red-blue-green (RGB)/depth cameras) to adapt communications (e.g., predict beamforming directions) in large-scale antenna arrays, such as used in millimeter wave (mmWave) and massive multiple-input multiple-output (MIMO) systems. These systems face two important challenges: (i) a large training overhead associated with selecting an optimal beam and (ii) a reliability challenge due to high sensitivity of mmWave and similar signals to link blockages. Interestingly, most devices that employ mmWave antenna arrays, such as 5G phones, self-driving vehicles, and virtual/augmented reality headsets, will likely also use cameras. Therefore, an efficient olution is presented which uses cameras at base stations and/or handsets to help overcome the beam selection and blockage prediction challenges.

### RELATED APPLICATIONS

This application claims the benefit of U.S. provisional patent application Ser. Nos. 62/989,256 and 62/989,179, filed Mar. 13, 2020, the disclosure of which is hereby incorporated herein by reference in its entirety.

### FIELD OF DISCLOSURE

This disclosure relates to using imaging to assist in wireless communication tasks, such as beamforming, blockage prediction, network analysis, and proactive resource allocation.

### BACKGROUND

Massive number of antennas and high frequencies are the two dominating characteristics of future wireless communication technologies. They both support the increasingly-high data rates that future technologies, like virtual/augmented reality and autonomous driving, are demanding. The transition towards high-frequency bands and large antenna arrays is evident in new and future technologies, such as the Third Generation Partnership Project (3GPP) Fifth Generation (5G) and Sixth Generation, which adopt dual-band operation by using sub-6 gigahertz (GHz) and millimeter-wave (mmWave) bands and support massive multiple-input multiple-output (MIMO) communications.

The increasing bandwidth and number of antennas do not come without cost. These features introduce substantial control overhead that can prevent realization of their full potential. As future wireless communications move to mmWave and higher frequencies, propagation characteristics severely change. For example, mmWaves are known for their weak penetration ability and significant power loss when they reflect off surfaces. This places strong emphasis on the need for antenna directivity, which commands large antenna arrays, and line-of-sight (LOS) connections. Hence, beamforming and blockage-prediction become critical tasks for any mmWave system. Both tasks are associated with large control overhead from the perspective of classical signal processing, which poses a major challenge to the support of mobility and reliability in these systems. That control overhead has ignited greater interest in intelligent (e.g., data-driven) solutions powered by machine learning and, in particular, its deep leaning paradigm.

### SUMMARY

Vision-aided wireless communications systems are provided. Embodiments disclosed herein leverage visual data sensors (such as red-blue-green (RGB)/depth cameras) to adapt communications (e.g., predict beamforming directions) in large-scale antenna arrays, such as used in millimeter wave (mmWave) and massive multiple-input multiple-output (MIMO) systems. These systems face two important challenges: (i) a large training overhead associated with selecting an optimal beam and (ii) a reliability challenge due to high sensitivity of mmWave and similar signals to link blockages. Interestingly, most devices that employ mmWave antenna arrays, such as 5G phones, self-driving vehicles, and virtual/augmented reality headsets, will likely also use cameras. Therefore, an efficient solution is presented which uses cameras at base stations and/or handsets to help overcome the beam selection and blockage prediction challenges.

In this regard, embodiments exploit computer vision and deep learning tools to predict mmWave beams and blockages directly from the camera RGB/depth images and sub-6 gigahertz (GHz) channels. Experimental results reveal interesting insights into the effectiveness of the solutions provided herein. For example, the deep learning model of certain embodiments is capable of achieving over 90% beam prediction accuracy, while only requiring a small number of images of the environment of users.

An exemplary embodiment provides a method for providing vision-aided wireless communications. The method includes receiving image data of an environment; analyzing the image data with a processing system; and adapting wireless communications with a wireless device based on the analyzed image data.

Another exemplary embodiment provides a network node. The network node includes communication circuitry configured to establish communications with a wireless device in an environment and a processing system. The processing system is configured to receive image data of the environment; perform an analysis of the environment in the image data; and adapt communications with the wireless device in accordance with the analysis of the environment.

Another exemplary embodiment provides a vision-aided wireless communications network. The network includes transceiver circuitry; an imaging device; and a processing system. The processing system is configured to cause the transceiver circuitry to communicate with a wireless device; receive image data from the imaging device; process and analyze the image data to determine an environmental condition of the wireless device; and adjust communications with the wireless device in accordance with the environmental condition of the wireless device.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of a wireless communication system deployed in an environment according to embodiments described herein.

FIG. 2 is a schematic block diagram of an exemplary vision-aided network node in an environment according to embodiments described herein.

FIG. 3 is a schematic block diagram of processing visual (image) data and wireless data of an environment according to embodiments described herein.

FIG. 4 is a schematic block diagram illustrating a blockage prediction solution according to embodiments described herein.

FIG. 5 is a schematic block diagram of an exemplary neural network for the blockage prediction solution of FIG. 4.

FIG. 6 is a flow diagram illustrating a process for providing vision-aided wireless communications.

FIG. 7 is a block diagram of a network node suitable for implementing vision-aided wireless communications according to embodiments disclosed herein.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Vision-aided wireless communications systems are provided. Embodiments disclosed herein leverage visual data sensors (such as red-blue-green (RGB)/depth cameras) to adapt communications (e.g., predict beamforming directions) in large-scale antenna arrays, such as used in millimeter wave (mmWave) and massive multiple-input multiple-output (MIMO) systems. These systems face two important challenges: (i) a large training overhead associated with selecting an optimal beam and (ii) a reliability challenge due to high sensitivity of mmWave and similar signals to link blockages. Interestingly, most devices that employ mmWave antenna arrays, such as 5G phones, self-driving vehicles, and virtual/augmented reality headsets, will likely also use cameras. Therefore, an efficient solution is presented which uses cameras at base stations and/or handsets to help overcome the beam selection and blockage prediction challenges.

In this regard, embodiments exploit computer vision and deep learning tools to predict mmWave beams and blockages directly from the camera RGB/depth images and sub-6 gigahertz (GHz) channels. Experimental results reveal interesting insights into the effectiveness of the solutions provided herein. For example, the deep learning model of certain embodiments is capable of achieving over 90% beam prediction accuracy, while only requiring a small number of images of the environment of users.

### I. Introduction

Sub-terahertz and mmWave communications are becoming dominant directions for current and future wireless networks. With their large bandwidths, they have the ability to satisfy the high data rate demands of several applications such as wireless virtual/augmented reality (VR/AR) and autonomous driving. Communication in these bands, however, faces several challenges at both the physical and network layers. One of the key challenges stems from the sensitivity of high-frequency signals (i.e., mmWave and sub-terahertz) to blockages. These signals suffer from high penetration loss and attenuation, resulting in strong dips in the received signal-to-noise ratio (SNR) whenever an object is present in-between a base station and a user. Such dips lead to sudden disruptions of the communication channel, which severely impact the reliability of wireless networks. Re-establishing line-of-sight (LOS) connection is usually done reactively (i.e., only after disruption of the communication channel), which brings about a hefty latency burden considering the ultra-reliable low-latency (URLL) requirement of emerging networks. Given all that, high-frequency wireless networks need not only establish and maintain LOS connections but also do so proactively, which implies a critical need for a sense of surrounding.

The aforementioned reliance on LOS draws a striking and important parallel with computer vision, in which visual data (e.g., images and video sequences) only captures visible, i.e., LOS, objects. This parallel is very interesting as computer vision systems rely on machine learning and visible objects to perform a variety of visual tasks depending on object appearance (object detection) and/or behavior (action recognition). In a wireless network, visible objects in the environment are usually the cause of link blockages, and, hence, a computer vision system powered with machine learning could be utilized to provide a much needed sense of surrounding to the network; it enables the network to identify objects in its environment and their behavior and utilize that to proactively detect possible blockages. Such capability helps alleviate the strain of link blockages, and as such, embodiments described herein focus on developing vision-aided communication systems, which can include dynamic beamforming and dynamic blockage prediction solutions, for high-frequency wireless networks.

Images and video sequences usually speak volumes about the environment they depict. As such, embodiments described herein develop a deep neural network that learns proactive adaptation (e.g., beamforming, blockage prediction, etc.) of wireless communications from sequences of jointly observed mmWave beams and image data (e.g., two-dimensional (2D) or three-dimensional (3D) still images, video frames, etc.). The majority of previous work adopting deep learning in mmWave communication systems has focused on wireless sensory data to drive the learning and deployment of intelligent solutions. Embodiments described herein seek to use other forms of sensory data to address control overhead issues. Accordingly, vision-aided wireless communications (VAWC) are described herein as a new holistic paradigm to tackle such overhead issues. VAWC ultimately utilizes not only depth and wireless data, but also RGB images to enable mobility and reliability in mmWave wireless communications.

In an exemplary aspect, VAWC is used to address beam and blockage prediction tasks using RGB, sub-6 GHz channels, and deep learning. When a predefined beamforming codebook is available, learning beam prediction from images degenerates to an image classification task. Depending on user location in a scene, each image could be mapped to a class represented by a unique beam index from the codebook. However, detecting blockage in still images could be slightly trickier than beams as the instances of no user and blocked user may be visually the same. Hence, images are paired with sub-6 GHz channels to identify blocked users. Each problem is studied in a single-user wireless communication setting.

In another aspect, a novel two-component deep learning architecture is proposed to utilize sequences of observed RGB frames and beamforming vectors and learn proactive link-blockage prediction. The architecture harnesses the power of convolutional neural networks (CNNs) and gated recurrent units (GRU) networks. The proposed architecture is leveraged to build a proactive hand-off solution. The solution deploys the two-stage architecture in different base stations, where it is used to predict possible future blockages from the perspective of each base station. Those predictions are streamed to a central unit that determines whether the communication session of a certain user in the environment will need to be handed over to a different base station.

The rest of this disclosure is organized as follows. Section II presents the system and channel models used to study the beam and blockage prediction problems. Section III presents the formulation of the two problems. Following that, a detailed discussion on the proposed vision-aided beam and blockage prediction solutions takes place in Section IV. Section V describes a method according to embodiments described herein. Finally, Section VI describes a computer system which can implement methods and systems described herein.

A. Notation

The following notation is used throughout this disclosure: A is a matrix, a is a vector, a is a scalar, and [symbol] is a set of vectors. In addition, ∥a∥ₚ is the p-norm of a, |A| is the determinant of A, A^{T} is the transpose of A, and A⁻¹ is the inverse of A. I is the identity matrix. [symbol] (m,R) is a complex Gaussian random vector with mean m and covariance R. [symbol] [⋅] is used to denote expectation.

### II. System and Channel Models

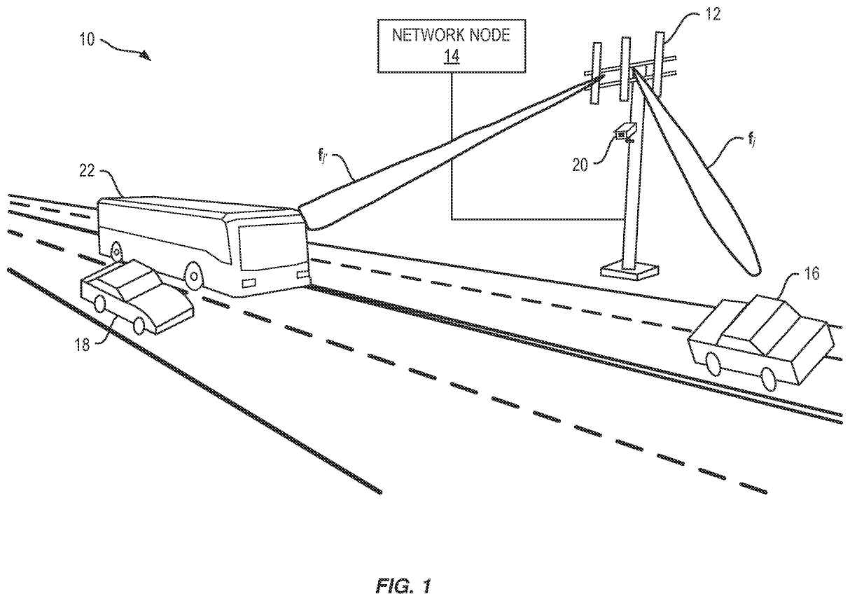

FIG. 1 is a schematic diagram of a wireless communication system deployed in an environment 10 (e.g., an outdoor environment) according to embodiments described herein. The wireless communication system includes an antenna array 12, which may be coupled to a network node 14 (e.g., a next generation base station (gNB) or other base station or network node). It should be understood that the network node 14 may be deployed at the antenna array 12, or it may be remotely located, and may control at least some aspects of wireless communications with wireless devices 16, 18. The network node 14 is further in communication with an imaging device 20, such as an RGB camera, to assist in adapting the wireless communications. In certain embodiments described herein, the network node 14 adapts wireless communications with one or more wireless devices 16, 18 based on video data. Further embodiments may also use additional environmental data in adapting wireless communications, such as global positioning system (GPS) data (e.g., received from the wireless devices 16, 18), audio data (e.g., from one or more microphones coupled to the network node 14), thermal data (e.g., from a thermal sensor coupled to the network node 14), etc.

It should be understood that the imaging device 20 can be any appropriate device for providing video data of the environment 10. For example, the imaging device 20 may be a camera or set of cameras (e.g., capturing optical, infrared, ultraviolet, or other frequencies), a radar system, a light detection and ranging (LIDAR) device, mmWave or other electromagnetic imaging device, or a combination of these. The imaging device 20 may be coupled to or part of a base station (e.g., the antenna array 12 and/or the network node 14), or it may be part of another device in communication with the network node 14 (e.g., a wireless device 16, 18). The video data captured by the imaging device 20 can include still and/or moving video data and can provide a two-dimensional (2D) or three-dimensional (3D) representation of the environment 20.

FIG. 1 illustrates the potential of deep learning and VAWC in adapting wireless communications with a first wireless device 16 and a second wireless device 18. The first wireless device 16 and the second wireless device 18 are illustrated as vehicles, but represent any device (mobile or stationary) configured to communicate wirelessly with the network node 14, such as a personal computer, cellular phone, internet-of-things (loT) device, etc. In an exemplary aspect, deep learning and VAWC are used to perform beam prediction (e.g., with the first wireless device 16) and predict and/or mitigate link blockage (e.g., with the second wireless device 18) in a high-frequency communication network. The link blockage can be dynamically mitigated by a number of different techniques, such as a hand-off, changing a wireless channel (e.g., a communication band), buffering the communications (e.g., to mitigate effects of a temporary blockage), etc. The following two subsections provide a more detailed description of the system and wireless channel models adopted to adapt such wireless communications.

A. System Model

In an illustrative example, the network node 14 and antenna array 12 are deployed as a small-cell mmWave base station in the environment 10 of FIG. 1. In an exemplary aspect, the base station (which may include one or both of the antenna array 12 and the network node 14) operates at both sub-6

GHz and mmWave bands. In some embodiments, the base station further operates at terahertz (THz) bands. The antenna array 12 may include an M_{mmW}-element mmWave antenna array and/or an M_{sub-6}-element sub-6 GHz antenna array (and may similarly include an M_{THz}-element THz antenna array). The imaging device 20 is an RGB camera. The system adopts orthogonal frequency-division multiplexing (OFDM) with K_{mmW} subcarriers at the mmWave band and K_{sub-6} subcarriers at sub-6 GHz.

Further, the mmWave base station is assumed to employ analog-only beamforming architecture while the sub-6 GHz transceiver is assumed to be fully-digital. For mmWave beamforming, it is assumed that the beam is selected from a predefined beam codebook [symbol] ={f₁, . . . , f_{B}}. To find the optimal beam, the user (e.g., the first wireless device 16) is assumed to send an uplink pilot that will be used to train the B beams and select the one that maximizes some performance metric, such as the received power or the achievable rate. This beam is then used for downlink data transmission.

If beam fⱼ is used in the downlink, then the received signal at the user's side can be expressed as:

yₖ^{mmW}=(hₖ^{mmW})^{T}fⱼsₖ^{mmW}+βₖ^{mmW} Equation 1

where hₖ^{nmW}∈ [symbol] ^{M}^{_{mmW}}^{×1} is the mmWave channel of the kth subcarrier, fⱼ∈ [symbol] ^{M}^{_{mmwx}}^{×1} is the jth beamforming vector in the codebook [symbol] , sₖ^{mmW} is the symbol transmitted on the kth mmWave subcarrier, and βₖ^{mmW}˜ [symbol] (0, σ²) is a complex Gaussian noise sample of the kth subcarrier frequency.

The second wireless device 18 experiences a link blockage 22 (e.g., from a large vehicle in the LOS between the second wireless device 18 and the antenna array 12). In an exemplary aspect, control signaling is provided between the wireless device 18 and the base station at sub-6 GHz. For blockage prediction, it is assumed that the base station will use the uplink signals on the sub-6 GHz band for this objective. If the mobile user sends an uplink pilot signal Sₖ^{sub-6}∈ [symbol] on the kth subcarrier, then the received signal at the base station can be written as:

yₖ^{sub-6}=hₖ^{sub-6}sₖ^{sub-6} Equation 2

where hₖ^{sub-6}∈ [symbol] ^{M}^{_{sub-}}6^{×1} is the sub-6 GHz channel of the kth subcarrier, and βₖ^{sub-6}˜ [symbol] (O, σ_{sub-6}²I) is the complex Gaussian noise vector of the kth subcarrier.

B. Channel Model

This disclosure adopts a geometric (physical) channel model for the sub-6 GHz and mmWave channels. With this model, the mmWave channel (and similarly the sub-6 GHz channel) can be written as:

$${h}_{k}^{mmW} = {\sum }_{d = 0}^{D - 1} {\sum }_{ℓ = 1}^{L} {α}_{ℓ} {e}^{- j \frac{2 π k}{K} d} p ( {dT}_{S} - {τ}_{ℓ} ) a ( {θ}_{ℓ} , {ϕ}_{ℓ} ) \qquad Equation 3$$

where L is number of channel paths, [symbol] , [symbol] , [symbol] , and [symbol] are the path gains (including the path-loss), the delay, the azimuth angle of arrival, and elevation, respectively, of the -e th channel path. T_{S} represents the sampling time while D denotes the cyclic prefix length (assuming that the maximum delay is less than DT_{S}). Note that the advantage of the physical channel model is its ability to capture the physical characteristics of the signal propagation including the dependence on the environment geometry, materials, frequency band, etc., which is crucial for considered beam and blockage prediction problems.

### III. Problem Formulation

Beam prediction, blockage prediction, and proactive hand-off to other antenna arrays 12 and/or network nodes 14 may be interleaved problems for many mmWave system. However, for the purpose of highlighting the potential of VAWC, they will be formulated and addressed separately in this disclosure. It should be understood that beam prediction, blockage prediction, and proactive hand-off are used herein as illustrative examples of adapting communications between the communication network (e.g., including the antenna array 12 and the network node 14) and the wireless devices 16, 18. Further embodiments adapt the communications based on analyzed image data (e.g., in conjunction with observations of wireless channels via transceivers and/or other sensor data) for beamforming signals (e.g., to initiate and/or dynamically adjust communications), predicting motion of objects and wireless devices 16, 18, MIMO communications via additional antenna arrays 12, performing proactive hand-off, switching communication channels, allocating wireless network resources, and so on.

A. Beam Prediction

The main target of beam prediction is to determine the best beamforming vector f* in the codebook [symbol] such that the received SNR at the receiver (e.g., the first wireless device 16) is maximized. As described herein, the problem is viewed from a different perspective than that in previous literature: the selection process depends on the image data from the imaging device 20 instead of explicit channel knowledge (i.e., hₖ^{mmW}) or beam training—both requiring large overhead. Mathematically, it could be expressed in one of the following two ways:

$${f}^{*} = {argmax}_{f ∈ ℱ} \frac{1}{K} {\sum }_{k = 1}^{K} 𝔼 [ ‖ {( {h}_{k}^{mmW} )}^{T} f {‖}_{2}^{2} ] \qquad Equation 4$$

$${f}^{*} = {argmax}_{f ∈ ℱ} \frac{1}{{k}_{mmw}} {\sum }_{k = 1}^{{K}_{mmw}} {log}_{2} ( 1 + ρ {\vert {f}^{T} {h}_{k}^{mmW} [ k ] \vert}^{2} ) \qquad Equation 5$$

where K is the total number of subcarriers. In an exemplary aspect, the optimal f* is found using an input image X∈ [symbol] ^{H×W×C}, where H, W, and C are, respectively, the height, width, and number of color channels of the image. This is done using a prediction function f_{Θ}(X) parameterized by a set of parameters Θ and outputs a probability distribution [symbol] ={p₁, . . . , p_{B}} over the vectors of [symbol] .

The index of the element with maximum probability determines the predicted beam vector,\hat{f}=f_{j*}, such that:

$${j}^{*} = {argmax}_{j ∈ \{ 1 , … , B \}} \{ {p}_{1} , … , {p}_{j} , … , {p}_{B} \} \qquad Equation 6$$

This function f_{Θ}(X) should be chosen to maximize the probability of correct prediction given an image X, i.e., [symbol] (\hat{f}=f_{j*}|X).

B. Blockage Prediction

Determining whether a LOS link of a user (e.g., the second wireless device 18) is blocked is a key task to boost reliability in mmWave systems. LOS status could be assessed based on some sensory data obtained from the communication environment. Some embodiments described herein use sequences of RGB images and beam indices to develop a machine learning model that learns to predict link blockages (i.e., transitions from LOS to non-LOS (NLOS)) proactively. Formally, this learning problem could be posed as follows. For any user u in the environment, a sequence of image and beam-index pairs is observed over a time interval of r instances. At any time instance τ∈ [symbol] , that sequence is given by

[symbol]

ᵤ={(Xᵤ[t],bᵤ[t])}_{t=τ-r+1}^{τ} Equation 7

where bᵤ[t] is the index of the beamforming vector in codebook [symbol] used to serve user u at the tth time instance, Xᵤ[t]∈ [symbol] ^{W×H×C} is an RGB mage of the environment taken at the tth time instance, W, H, and C are respectively the width, height and the number of color channels for the image, and r∈ [symbol] is the extent of the observation interval.

For robust network operation, the objective is to observe [symbol] ᵤ and predict whether a blockage will occur within a window of r′∈ [symbol] future instances, without focusing on the exact future instance. Let [symbol] ᵤ={aᵤ[t]}_{t=τ+1}^{τ+r′} represents the window (sequence) of r′ future link statuses of the uth user, where aᵤ[t]∈{0,1} represents the link status at the tth future time instance; and 0 and 1 are, respectively, LOS and NLOS links. Then, the user's future link status sᵤ in the window [symbol] ᵤ (henceforth referred to as the future link status) could be defined as

$${s}_{u} = \{ \begin{matrix}0 , {a}_{u} [ t ] , ∀ t ∈ \{ τ + 1 , … , τ + {r}^{′} \} \\ 1 , otherwise\end{matrix} \qquad Equation 8$$

where 0 indicates a LOS connection is maintained throughout the window [symbol] ᵤ and 1 indicates the occurrence of a link blockage within that window.

The primary objective is attained using a machine learning model. It is developed to learn a prediction function ƒ_{Θ}( [symbol] ) that takes in the observed image-beam pairs and produces a prediction on the future link status ŝ∈{0,1}. This function is parameterized by a set Θ representing the model parameters and learned from a dataset of labeled sequences. To put this in formal terms, let [symbol] ( [symbol] , s) represent a joint probability distribution governing the relation between the observed sequence of image-beam pairs [symbol] and the future link status s in some wireless environment, which reflects the probabilistic nature of link blockages in the environment.

A dataset of independent pairs [symbol] ={( [symbol] ᵤ, sᵤ)}ᵤ₌₁^{U} where ( [symbol] ᵤ, sᵤ) is sampled at random from [symbol] ( [symbol] , s)−sᵤ is serving as a label for the observed sequence Sᵤ. This dataset is then used to train the prediction function f_{Θ}( [symbol] ) such that it maintains high-fidelity predictions for any dataset drawn from [symbol] ( [symbol] , s). This could be mathematically expressed as

$${\prod }_{u = 1}^{U} ℙ ( {\hat{s}}_{u} = {s}_{u} \vert {u}_{} ) \qquad Equation 9$$

where the joint probability in Equation 9 is factored out as a result of independent and identically distributed samples in [symbol] . This conveys an implicit assumption that for any user u in the environment, the success probability of f_{Θ}( [symbol] ᵤ) predicting sᵤ only depends on its observed sequence [symbol] ᵤ.

C. Proactive Hand-Off

A direct consequence of proactively predicting blockages is the ability to do proactive user hand-off. In some embodiments, blockage prediction is further used for a hand-off between two high-frequency base stations (e.g., between different antenna arrays 12 and/or different network nodes 14) based on the availability of a LOS link to a user (e.g., the second wireless device 18). Let [symbol] ᵤ⁽ⁿ⁾={(Xᵤ⁽ⁿ⁾[t], bᵤ⁽ⁿ⁾[t])}_{t=τ-r+1}^{τ} and ti [symbol] ᵤ^{(n′)}={(Xᵤ^{(n′)}[t], bᵤ^{(n′)}[t])}_{t=τ-r+1}^{τ} respectively represent the sequences of observed image-beam pairs for the uth user at base station n and n′, where n, n′∈{1,2} such that n≠n′. Each of these two sequences is associated with its own future link status, namely sᵤ⁽ⁿ⁾ and sᵤ^{(n′)}, which are defined similarly to Equation 8. The goal is to determine, with high confidence, when a user (e.g., second wireless device 18) served by one antenna array 12 and network node 14 needs to be handed off to another antenna array 12 and/or network node 14 given the observed two sequences [symbol] ᵤ⁽ⁿ⁾ and [symbol] ᵤ^{(n′)}. Let zᵤ ^{nn′∈{}0,1} be a binary random variable indicating whether the uth user needs to be handed off from base station n to base station n′, where 1 means a hand-off is needed and 0 means it is not, and let \hat{Z}ᵤ^{nn′∈{}0,1} be a prediction of the value of Zᵤ^{nn′} for user u. The hand-off confidence is, then, formally described by the conditional probability of successful hand-off, [symbol] (\hat{Z}ᵤ^{nn′}=Zᵤ^{nn′}|( [symbol] ᵤ⁽ⁿ⁾, [symbol] ᵤ^{(n′)}).

The probability of successful hand-off in the case of two base stations (representing a hand-off between different antenna arrays 12 coupled to a common network node 14 or between antenna arrays 12 coupled to different network nodes 14) depends on the future link status between a user and those two base stations, and, as such, that probability could be quantified using the predicted and ground truth future link statuses of the two base stations. Define the tuple of link status predictions (ŝᵤ⁽ⁿ⁾, ŝᵤ^{(n′)}, sᵤ⁽ⁿ⁾, sᵤ^{(n′)}. Then, the event of successful hand-off could be formally expressed as follows

$$= 〛 \{ {\hat{z}}_{u}^{{nn}^{′}} = {z}^{{nn}^{′}} \} = \{ \begin{matrix}0 , ( {\hat{s}}_{u}^{( n )} , {\hat{s}}_{u}^{( {n}^{′} )} , {s}_{u}^{( n )} , {s}_{u}^{( {n}^{′} )} ) ∈ {ε}_{1} \\ 1 , ( {\hat{s}}_{u}^{( n )} , {\hat{s}}_{u}^{( {n}^{′} )} , {s}_{u}^{( n )} , {s}_{u}^{( {n}^{′} )} ) ∈ {ε}_{1}\end{matrix} \qquad Equation 10$$

where ε₀={(0,0,0,0), (0,1,0,1), (1,1,1,1), (1,1,0,0), (1,1,0,1), (0,1,0,0), (0,0,0,1)} indicates the set of tuples (or events) that amount to a successful no hand-off decision while ε₁={(1,0,1,0)} is the set of tuples amounting to a successful hand-off decision. Guided by Equation 10, the conditional probability of successful hand-off could be written as

[symbol]

(\hat{Z}ᵤ^{nn′}=Z^{nn′}| [symbol] ᵤ⁽ⁿ⁾, [symbol] ᵤ^{(n′)}) = [symbol] (\hat{s}ᵤ⁽ⁿ⁾=1,\hat{s}ᵤ^{(n′)}=0|sᵤ⁽ⁿ⁾=1,sᵤ^{(n′)}=0 [symbol] ᵤ⁽ⁿ⁾, [symbol] ᵤ^{(n′)}) [symbol] (sᵤ⁽ⁿ⁾=1,sᵤ^{(n′)}=0) + [symbol] (\hat{s}ᵤ⁽ⁿ⁾=1,\hat{s}ᵤ^{(n′)}=1|sᵤ⁽ⁿ⁾=1,sᵤ^{(n′)}=1 [symbol] ᵤ⁽ⁿ⁾, [symbol] ᵤ^{(n′)}) [symbol] (sᵤ⁽ⁿ⁾=1,sᵤ^{(n′)}=1) + [symbol] (\hat{s}ᵤ⁽ⁿ⁾=1, \hat{s}ᵤ^{(n′)}=1|sᵤ⁽ⁿ⁾=0,sᵤ^{(n′)}=0, [symbol] ᵤ⁽ⁿ⁾, [symbol] ᵤ^{(n′)}) [symbol] (sᵤ⁽ⁿ⁾=1,sᵤ^{(n′)}=1) + [symbol] (\hat{s}ᵤ⁽ⁿ⁾=1, \hat{s}ᵤ^{(n′)}=1|sᵤ⁽ⁿ⁾=0,sᵤ^{(n′)}=1, [symbol] ᵤ⁽ⁿ⁾, [symbol] ᵤ^{(n′)}) [symbol] (sᵤ⁽ⁿ⁾=0,sᵤ^{(n′)}=1) + [symbol] (\hat{s}ᵤ⁽ⁿ⁾=0|sᵤ⁽ⁿ⁾=0, [symbol] ₙ⁽ⁿ⁾) [symbol] (sᵤ⁽ⁿ⁾=0)

Equation 11 is lower bounded by the probability of joint successful link-status prediction given [symbol] ᵤⁿ) and [symbol] ᵤ^{(n′)}

$$ℙ ( {\hat{z}}_{u}^{{nn}^{′}} = {z}^{{nn}^{′}} \vert {u}_{( n )}^{} , {u}_{( {n}^{′} )}^{} ) \geq {\sum }_{v = 0}^{1} {\sum }_{{v}^{′} = 0}^{1} ℙ ( {\hat{s}}_{u}^{( n )} = v , {\hat{s}}_{u}^{( {n}^{′} )} = {v}^{′} \vert {s}_{u}^{( n )} = v , {s}_{u}^{( {n}^{′} )} = {v}^{′} , {u}_{( n )}^{} , {u}_{( {n}^{′} )}^{} ) ℙ ( {s}_{u}^{( n )} = v , {s}_{u}^{( {n}^{′} )} = {v}^{′} ) = ℙ ( {\hat{s}}_{u}^{( n )} = {s}_{u}^{( n )} , {\hat{s}}_{u}^{( {n}^{′} )} = {s}_{u}^{( {n}^{′} )} \vert {u}_{( n )}^{} , {u}_{( {n}^{′} )}^{} ) \qquad Equation 12$$

Using two blockage-prediction functions f_{Θ}( [symbol] ⁽ⁿ⁾) and f_{Θ}( [symbol] ^{(n′)}) (one per base station), successful proactive hand-off could be viewed from the lens of blockage prediction. More specifically, Equation 12 indicates that maximizing the conditional probability of joint successful link-status prediction guarantees high-fidelity hand-off prediction. Thus, the two functions f_{Θ}( [symbol] ⁽ⁿ⁾) and f_{Θ}( [symbol] ^{(n′)}) need to be learned such that

$${max}_{f Θ ( {( n )}^{} ) , f Θ ( {( {n}^{′} )}^{} )} {\prod }_{u = 1}^{U} ℙ ( {\hat{s}}_{u}^{( n )} = {s}_{u}^{( n )} , {\hat{s}}_{u}^{( {n}^{′} )} = {s}_{u}^{( {n}^{′} )} \vert {u}_{( n )}^{} , {u}_{( {n}^{′} )}^{} ) \qquad Equation 13$$

where U is the total number of samples drawn from the probability distribution [symbol] (sᵤ⁽ⁿ⁾), sᵤ^{(n′)}, [symbol] ᵤ⁽ⁿ⁾, [symbol] ᵤ^{(n′)}) that governs the relation between the observed sequences [symbol] ᵤ⁽ⁿ⁾ and [symbol] ᵤ^{(n′)} and the future link statuses sᵤ⁽ⁿ⁾ and sᵤ^{(n′)}.

### IV. Proposed Vision-Aided Solution

This section describes proposed solutions for vision-aided beam prediction, blockage prediction, and proactive hand-off using deep learning.

A. mmWave Beam Prediction

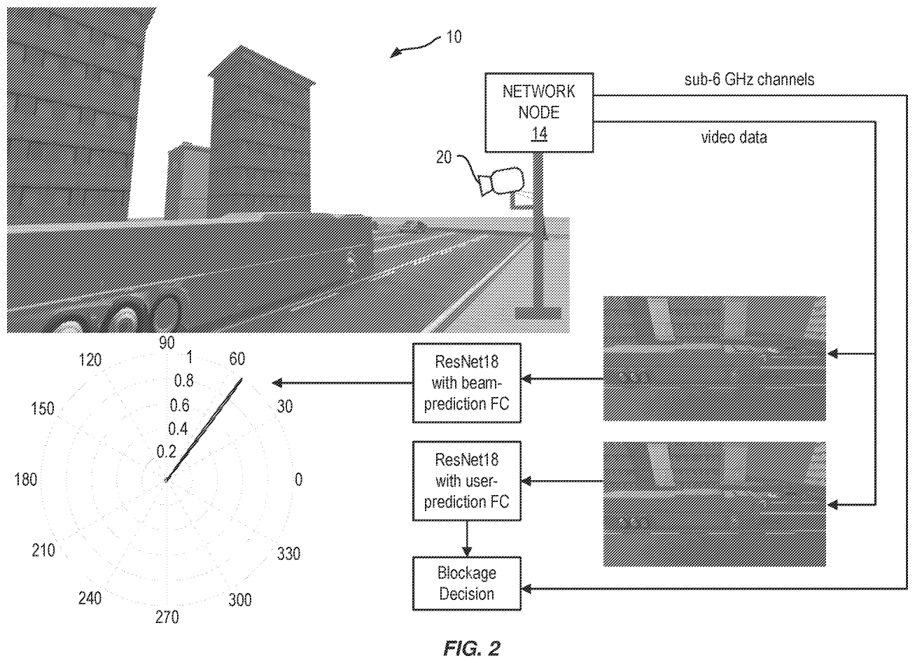

FIG. 2 is a schematic block diagram of an exemplary vision-aided network node 14 in an environment 10 according to embodiments described herein. Two 18-layer residual network (ResNet-18) models are deployed to learn beam prediction and user detection, respectively. Each network has a customized fully-connected layer that suits the task it handles. A network is trained to directly predict the beam index while the other predicts the user existence (detection) which is then converted to blockage prediction (e.g., using additional data, such as a sub-6 GHz channel). In some embodiments, the beam prediction is enhanced through the use of other sensors (e.g., environmental sensors such as audio, light, or thermal sensors). In addition, the environment 10 may include markers, such as visual or electromagnetic markers (e.g., optical or other signals, static reflective markers, etc.) on the wireless devices 16,18 to assist with locating and tracking the wireless devices.

In this regard, deep learning-based solutions are proposed for each problem of beam and blockage predictions. Both solutions rely on deep convolutional networks and the concept of transfer learning. In the illustrated embodiment, the cornerstone in each solution is the ResNet-18, which is described further in K. He, X. Zhang, S. Ren, and J. Sun, “Deep residual learning for image recognition,” in Proceedings of the IEEE conference on computer vision and pattern recognition, 2016, pp. 770-778. Each ResNet-18 (or another appropriate neural network) can be trained with an image database, such as ImageNet2012 (described in 0. Russakovsky, J. Deng, H. Su, J. Krause, S. Satheesh, S. Ma, Z. Huang, A. Karpathy, A. Khosla, M. Bernstein et al., “Imagenet large scale visual recognition challenge,” International journal of computer vision, vol. 115, no. 3, pp. 211-252,2015), and fine-tuned for the problem of interest.

The idea of predicting the best beamforming vector from a codebook using an image has a strong analogy with image classification. The beam vectors divide the scene (spatial dimensions) into multiple sectors, and the goal of the system is to identify to which sector a user belongs. Assigning images to classes labeled by beam indices can be readily accomplished in LOS situations, as this relies on knowledge of the user's location in the scene. Hence, the objective is to learn the class-prediction function f_{Θ}(X) (see Section III-A above) using images from the environment.

The proposed approach to learn the prediction function is based on deep convolutional neural networks and transfer learning. A pre-trained ResNet-18 model is adopted and customized to fit the beam prediction problem—its final fully-connected layer is removed and replaced with another fully-connected layer with a number of neurons equal to the codebook size, B neurons. This model is then fine-tuned, in a supervised fashion, using images from the environment that are labeled with their corresponding beam indices. It basically learns the new classification function (i.e., f _{Θ}(X)), that maps an image to a beam index. The training is conducted with a cross-entropy loss given by:

l=Σᵢ₌₁^{B}tᵢ log pᵢ Equation 14

where tᵢ is 1 if i is the beam index and 0 otherwise. pᵢ is the probability distribution induced by the soft-max layer.

This beam prediction approach can be extended to link blockage prediction. The blockage prediction problem is not very different from beam prediction in terms of the learning approach—it relies on detecting the user in the scene, and, thus, it could be viewed as a binary classification problem where a user is either detected or not. This, from a wireless communication perspective, is problematic as the absence of the user from the visual scene does not necessarily mean it is blocked—it could simply mean that it does not exist. As a result, embodiments described herein integrate images with sub-6 GHz channels to distinguish between absent and blocked users.

A valid question might arise at this point: why would the system not predict the link status from sub-6 GHz channels directly? This is certainly an interesting question, and it has been shown that neural networks can effectively learn blockage prediction from sub-6 GHz channels. However, a major issue with that approach is a need for labeled channels—there is no clear signal processing method for labelling sub-6 channels as blocked or not, and, on the other hand, labelling images is relatively easier. Therefore, a network trained to detect users could help predict blockages from still images when it is combined with sub-6GHz channels. This approach could be used to label sub-6 GHz channels and use them later for training models to learn blockage prediction from sub-6 GHz directly.

Blockage prediction here is performed in two stages: i) user detection using a deep neural network, and ii) link status assessment using sub-6 GHz channels and the user-detection result. The neural network of choice for this task is also a ResNet-18 but with a 2-neuron fully-connected layer. Similar to Section III-A, it can be pre-trained with an image database, such as ImageNet2012, and fine-tuned on some images from the environment. It is first used to predict whether a user exists in the scene or not. If a user is detected, the link status is directly declared as unblocked. On the other hand, when the user is not detected, sub-6 GHz channels come into play to identify whether this is because it is blocked or it does not exist. When those channels are not zero, this means a user exists in the scene and it is blocked. Otherwise, a user is declared absent.

B. Blockage Prediction

1. Key Idea

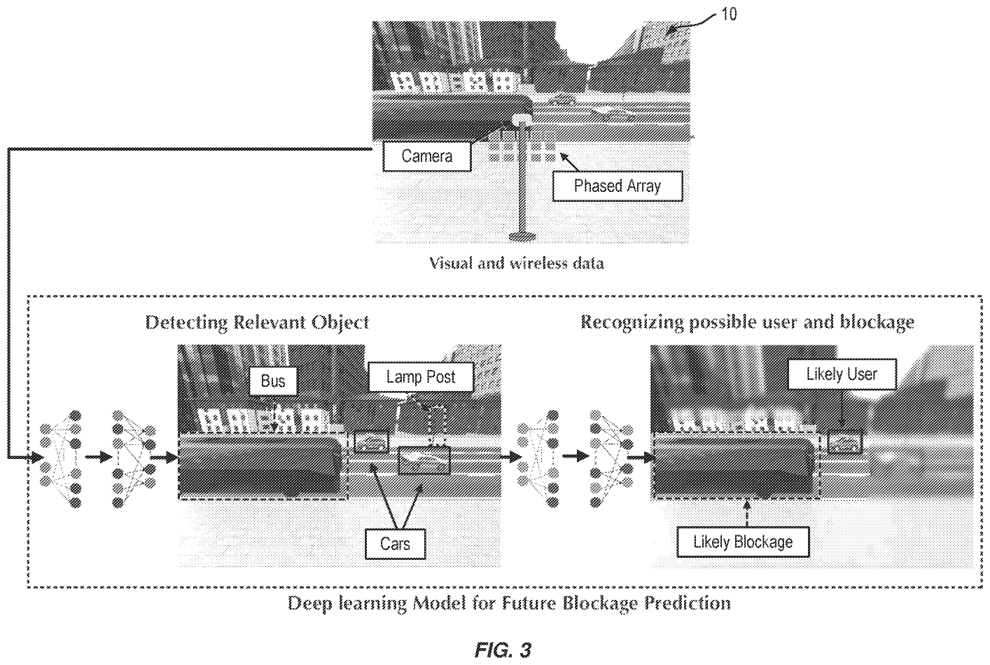

FIG. 3 is a schematic block diagram of processing visual (image) data and wireless data of an environment 10 according to embodiments described herein. Embodiments aim to predict future link blockages using deep learning algorithms and a fusion of both vision and wireless data (e.g., at the network node 14 of FIGS. 1 and 2, which can incorporate or be coupled to a base station). In progressing from a single-user and stationary blockage (as described above) to a more realistic scenario with multiple moving objects and dynamic blockages, the task of future blockage prediction becomes far more challenging. A successful prediction of future link blockages in a realistic scene hinges, to a large extent, on the following two notions. First, the ability to detect and identify relevant objects in the wireless environment, objects that could be wireless users or possible link blockages. This includes detecting humans in the scene; different vehicles such as cars, buses, trucks, etc.; and other probable blockages such as trees, lamp posts, etc. Second, the ability to zero in on the objects of interest, i.e., the wireless user and its most likely future blockage. Only detecting relevant objects is not sufficient to predict future blockages; it needs to be augmented with the ability to recognize which of those objects is the probable user and which of them is the probable blockage. This recognition narrows the analysis of the scene to the two objects of interest and helps answer the questions of whether and when a blockage will happen.

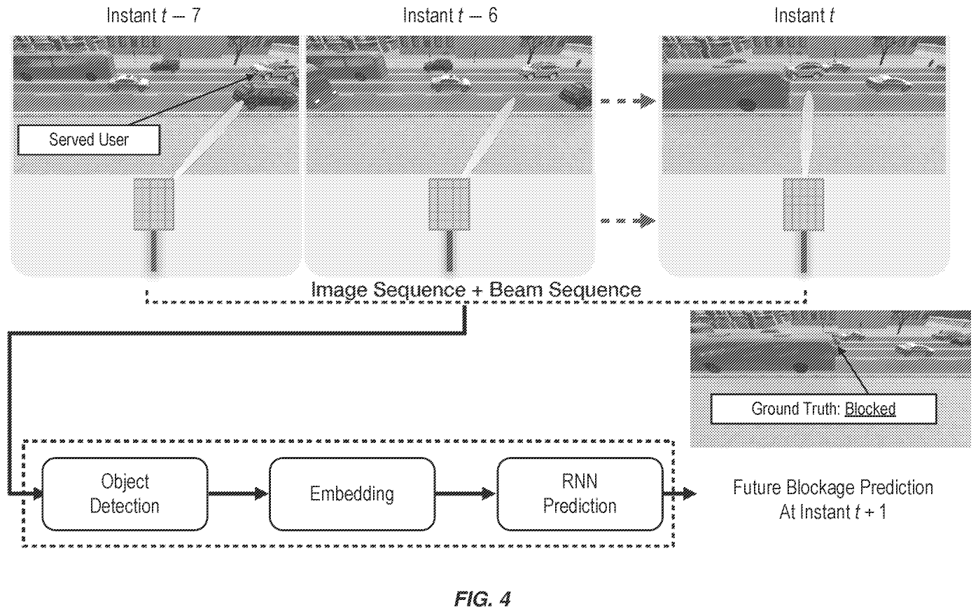

FIG. 4 is a schematic block diagram illustrating a blockage prediction solution according to embodiments described herein. Guided by the above notions, the prediction function f_{Θ}( [symbol] ) (or the proposed solution) is designed to break down blockage prediction into two sequential sub-tasks with an intermediate embedding stage. The first sub-task attempts to embody the first notion mentioned above. A machine learning algorithm could detect relevant objects in the scene by relying on visual data alone as it has the needed appearance and motion information to do the job. Given recent advances in deep learning, this sub-task is well-handled with CNN-based object detectors.

The next sub-task embodies the second notion, recognizing the objects of interest among all the detected objects. Wireless data is brought into the picture for this sub-task. More specifically, mmWave beamforming vectors could be utilized to help with that recognition process. They provide a sense of direction in the 3D space (i.e., the wireless environment), whether it is an actual physical direction for well-calibrated and designed phased arrays or it is a virtual direction for arrays with hardware impairments. That sense of direction could be coupled with the set of relevant objects using an embedding stage. In particular, some embodiments observe multiple bimodal tuples of beams and relevant objects over a sequence of consecutive time instances, embed each tuple into high-dimensional features, and boil down the second sub-task to a sequence modeling problem. A recurrent neural network (RNN) is used to implicitly learn the recognition sub-task and produce predictions of future blockages, which is the ultimate goal of the solution.

2. Blockage Prediction Solution

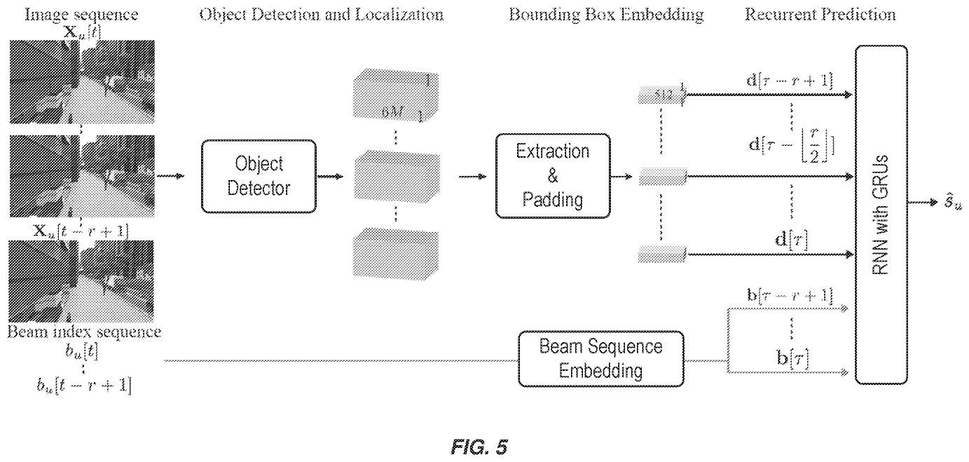

FIG. 5 is a schematic block diagram of an exemplary neural network for the blockage prediction solution of FIG. 4. The neural network architecture includes three main components: object detection, bounding box extraction and beam embedding, and recurrent prediction.

a. Object Detection

The object detector in the proposed solution needs to meet two essential requirements: (i) detecting a wide range of objects and (ii) producing quick and accurate predictions. These two requirements have been addressed in many of the state-of-the-art object detectors. A good example of a fast and accurate object-detection neural network is the You Only Look Once (YOLO) detector, proposed first in J. Redmon, S. Divvala, R. Girshick, and A. Farhadi, “You Only Look Once: Unified, Real-Time Object Detection,” in Proceedings of the IEEE Conference on Computer Vision and Pattern Recognition, 2016, pp. 779-788 and then improved in J. Redmon and A. Farhadi, “YOLO9000: Better, Faster, Stronger,” in Proceedings of the IEEE Conference on Computer Vision and Pattern Recognition, 2017, pp. 7263-7271. The latest YOLO architecture, YOLOv3, is the best in terms of detection accuracy, and as such, some embodiments adopt it as the object detector.

Choice of object detector: The YOLOv3 detector is a fast and reliable end-to-end object detection system, targeted for real-time processing. It is a fully convolutional neural network with a feature extraction layer and an output processing layer. Darknet-53 is the backbone feature extractor in YOLO, and the processing output layer is similar to the feature pyramid network (FPN). Darknet-53 comprises 53 convolutional layers, each followed by batch normalization layer and Leaky ReLU activation. In the convolutional layers, 1×1 and 3×3 filters are used. Instead of a conventional pooling layer, convolutional filters with stride 2 are used to downsample the feature maps. This prevents the loss of fine-grained features as the layers learn to downsample the input during training. YOLO makes detection in 3 different scales in order to accommodate different object sizes by using strides of 32, 16, and 8. This method of performing detection at different layers helps address the issue of detecting smaller objects. The features learned by the convolutional layers are passed on to the classifier, which generates the detection prediction. Since the prediction in YOLOv3 is performed using a convolutional layer consisting of 1×1 filters, the output of the network is a feature map consisting of the bounding box co-ordinates, the objectness score, and the class prediction. The list of bounding box co-ordinates consists of top-left co-ordinates and the height and width of the bounding box. Embodiments compute the center co-ordinates of each of the bounding boxes from the top-left and the height and the width of the box.

Integration of object detector: Instead of building and training the YOLOv3 from scratch, the proposed solution utilizes a pre-trained YOLO network and integrates it into its architecture with some minor modifications. First, the network architecture is modified to detect the objects of interest, e.g., cars, buses, trucks, trees, etc.; the number of those objects and their types (classes) are selected based on the target wireless environment in which the proposed solution is going to be deployed. For any choice of the number of objects and classes, the modification on the YOLOv3 architecture only affects the size of the classifier layer, which allows us to take advantage of the other trained layers. Second, the YOLOv3 network with the modified classifier is then fine-tuned using a dataset resembling the target wireless environment. This step adjusts the classifier and, as the name suggests, fine-tune the rest of the architecture to be more attentive to the objects of interest.

b. Bounding Box Extraction and Beam Embedding

The prediction function relies on dual-modality observed data, i.e., visual and wireless data. Although such data is expected to be rife with information, its dual nature brings about a heightened level of difficulty from the learning perspective. In an effort to overcome that difficulty, the proposed solution incorporates an embedding component that processes the extracted bounding box values and the beam indices separately, as shown in the embedding component of FIG. 5. It transforms them to the same N-dimensional space before they are fed to the next component. For beam indices in the input sequence, the adopted embedding is simple and does not require any training. It generates a lookup table of | [symbol] | real-valued vectors b[t]∈ [symbol] ^{N} where t∈{τ−r+1, . . . , τ}. The elements of each vector are randomly drawn from a Gaussian distribution with zeros mean and unity standard deviation.

Bounding boxes output by the object detector undergo a simple transform-and-stack operation. In particular, each bounding box is transformed into a 6-dimensional vector comprising the center co-ordinates [x_{cent}, y_{cent}], the bottom left co-ordinates [x₁, y₁], and the top right co-ordinates [x₂, y₂]. The co-ordinates are normalized to fall in the interval [0,1]. They, collectively, help in marking the exact location of an object in the scene. Then, the transformed bounding boxes of one image (or video frame) are stacked to form one high-dimensional vector \tilde{d}[t]∈ [symbol] ^{6M×1}, where M is the number of objects detected in an image and t∈{τ−r+1, . . . , τ}. Since the solution is proposed for dynamic wireless environments, the number of objects in each image is not fixed, resulting in a variable-length \tilde{d}[t]. Therefore, \tilde{d}[t] is padded by N−M zeros to transform it into a fixed length vector d[t]∈ [symbol] ^{N×1}.

c. Recurrent Prediction

CNN networks inherently fail in capturing sequential dependencies in input data; thereby, they are not expected to learn the relation within a sequence of embedded features. To overcome that, the third component of the proposed architecture utilizes RNNs and performs future blockage prediction based on the learned relation among those features. In particular, the recurrent component has two layers of GRU separated by a dropout layer. These two layers are followed by a fully-connected layer that acts as a classifier. The recurrent component receives a sequence of length 2r of bounding-box and beam embeddings, i.e., a sequence of the form {d[τ−r+1], . . . , d[τ], b[τ−r+1], . . . , b [τ]}. Hence, it implements 2r GRUs per layer. The output of the last unit in the second GRU layer is fed to the classifier to predict the future link status ŝᵤ.

C. Proactive Hand-Off

A major advantage of proactive blockage prediction is that it enables mitigation measures for LOS-link blockages in small-cell high-frequency wireless networks, such as proactive user hand-off. The predictions of a vision-aided blockage prediction algorithm could serve as a means to anticipate blockages and re-assign users based on LOS link availability. To illustrate that, the deep learning architecture presented in Section IV-B is deployed in a simple network setting, which embodies the setting adopted in Section III. Two adjacent small-cell high-frequency base stations are assumed to operate in the same wireless environment. They are both equipped with RGB cameras that monitor the environment, and they are also running two copies of the proposed deep architecture. A common central unit is assumed to control both base stations and have access to their running deep architectures. Each user in the environment is connected to both base stations but is only served by one of them at any time, i.e., both base stations keep a record of the user's best beamforming vector at any coherence time, but only one of them is servicing that user. The objective in this setting is to learn two blockage-prediction functions and use their predictions in the central unit to perform proactive user hand-off. More formally, embodiments aim to learn the two prediction functions f_{Θ}( [symbol] ⁽ⁿ⁾) and f_{Θ}( [symbol] ^{(n′)}) that could maximize Equation 13.

Proposed user hand-off solution: From Equation 13, functions f_{Θ}( [symbol] ⁽ⁿ⁾) and f_{Θ}( [symbol] ^{(n′)}) need to maximize the joint conditional probability of successful link-blockage prediction. Such requirement, albeit being accurate, may not be computationally practical as it requires a joint learning process, which may not scale well in an environment with multiple small-cell base stations. Thus, some embodiments train two independent copies of the blockage prediction architecture on two separate datasets, each of which is collected by one base station. This choice could be formally translated into a conditional independence assumption in Equation 13. More specifically, for the uth user, the event of successful link-status prediction at base station n, i.e., {ŝᵤ⁽ⁿ⁾=sᵤ⁽ⁿ⁾| [symbol] ᵤ⁽ⁿ⁾} is independent from that of the same user at base station n′, i.e., {ŝᵤ^{(n′)}=sᵤ^{(n ′)}| [symbol] ᵤ^{(n′)}}. The intuition behind this assumption is rooted in the camera orientation at each base station; each camera could view the environment from a different view-angle, which could result in different object positions, object orientations, motion directions, and image background. The trained deep architectures are deployed once they reach some satisfying generalization performance. At any time instance, the two architectures feed their predictions to the central unit, and the unit uses them to anticipate whether a user should be handed off or not (i.e., z^{nn′}=1∀n, n′∈{1,2} and n≠n′). A hand-off is only initiated when the LOS link at the serving base station is predicted to be blocked while the LOS link at the other base station is predicted to be maintained.

### V. Flow Diagram

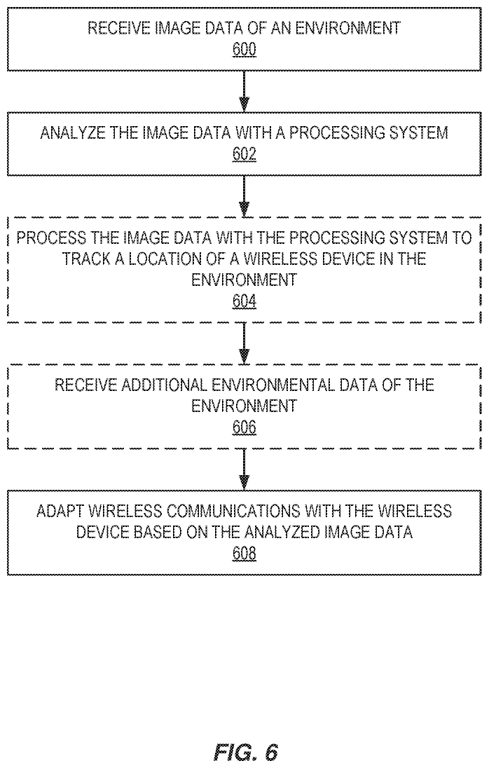

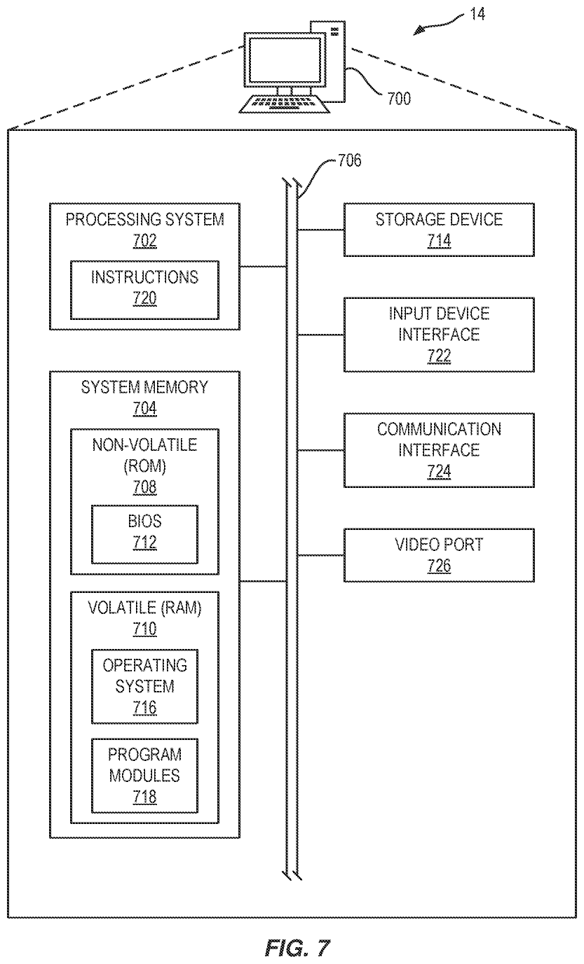

FIG. 6 is a flow diagram illustrating a process for providing vision-aided wireless communications. Dashed boxes represent optional steps. The process begins at operation 600, with receiving image data of an environment. In an exemplary aspect, the image data is received concurrently with other data, such as signals received from a wireless device in the environment or environmental data from other sensors. The process continues at operation 602, with analyzing the image data with a processing system. The processing system can represent one or more processors or other logic devices, such as described further below with respect to FIG. 7. The process optionally continues at operation 604, with processing the image data with the processing system to track a location of the wireless device in the environment. The process optionally continues at operation 606, with receiving additional environmental data of the environment (e.g., from another sensor). The process continues at operation 608, with adapting wireless communications with the wireless device based on the analyzed image data.

Although the operations of FIG. 6 are illustrated in a series, this is for illustrative purposes and the operations are not necessarily order dependent. Some operations may be performed in a different order than that presented. Further, processes within the scope of this disclosure may include fewer or more steps than those illustrated in FIG. 6.

### VI. System Diagram

FIG. 7 is a block diagram of a network node 14 suitable for implementing VAWC according to embodiments disclosed herein. The network node 14 includes or is implemented as a computer system 700, which comprises any computing or electronic device capable of including firmware, hardware, and/or executing software instructions that could be used to perform any of the methods or functions described above. In this regard, the computer system 700 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 700 in this embodiment includes a processing system 702 (e.g., a processor or group of processors), a system memory 704, and a system bus 706. The system memory 704 may include non-volatile memory 708 and volatile memory 710. The non-volatile memory 708 may include read-only memory (ROM), erasable programmable read-only memory (EPROM), electrically erasable programmable read-only memory (EEPROM), and the like. The volatile memory 710 generally includes random-access memory (RAM) (e.g., dynamic random-access memory (DRAM), such as synchronous DRAM (SDRAM)). A basic input/output system (BIOS) 712 may be stored in the non-volatile memory 708 and can include the basic routines that help to transfer information between elements within the computer system 700.

The system bus 706 provides an interface for system components including, but not limited to, the system memory 704 and the processing system 702. The system bus 706 may be any of several types of bus structures that may further interconnect to a memory bus (with or without a memory controller), a peripheral bus, and/or a local bus using any of a variety of commercially available bus architectures.

The processing system 702 represents one or more commercially available or proprietary general-purpose processing devices, such as a microprocessor, central processing unit (CPU), or the like. More particularly, the processing system 702 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing system 702 is configured to execute processing logic instructions for performing the operations and steps discussed herein.

In this regard, the various illustrative logical blocks, modules, and circuits described in connection with the embodiments disclosed herein may be implemented or performed with the processing system 702, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein.

Furthermore, the processing system 702 may be a microprocessor, or may be any conventional processor, controller, microcontroller, or state machine. The processing system 702 may also be implemented as a combination of computing devices (e.g., a combination of a DSP and a microprocessor, a plurality of microprocessors, one or more microprocessors in conjunction with a DSP core, or any other such configuration). In some examples, the processing system 702 may be an artificially intelligent device and/or be part of an artificial intelligence system.

The computer system 700 may further include or be coupled to a non-transitory computer-readable storage medium, such as a storage device 714, which may represent an internal or external hard disk drive (HDD), flash memory, or the like. The storage device 714 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 716 and any number of program modules 718 or other applications can be stored in the volatile memory 710, wherein the program modules 718 represent a wide array of computer-executable instructions corresponding to programs, applications, functions, and the like that may implement the functionality described herein in whole or in part, such as through instructions 720 on the processing device 702. The program modules 718 may also reside on the storage mechanism provided by the storage device 714. As such, all or a portion of the functionality described herein may be implemented as a computer program product stored on a transitory or non-transitory computer-usable or computer-readable storage medium, such as the storage device 714, volatile memory 708, non-volatile memory 710, instructions 720, and the like. The computer program product includes complex programming instructions, such as complex computer-readable program code, to cause the processing device 702 to carry out the steps necessary to implement the functions described herein.

An operator, such as the user, may also be able to enter one or more configuration commands to the computer system 700 through a keyboard, a pointing device such as a mouse, or a touch-sensitive surface, such as the display device, via an input device interface 722 or remotely through a web interface, terminal program, or the like via a communication interface 724. The communication interface 724 may be wired or wireless and facilitate communications with any number of devices via a communications network in a direct or indirect fashion. An output device, such as a display device, can be coupled to the system bus 706 and driven by a video port 726. Additional inputs and outputs to the computer system 700 may be provided through the system bus 706 as appropriate to implement embodiments described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

Those skilled in the art will recognize improvements and modifications to the preferred embodiments of the present disclosure. All such improvements and modifications are considered within the scope of the concepts disclosed herein and the claims that follow.

What is claimed is:

1. A method for providing vision-aided wireless communications, the method comprising:
receiving image data of an environment;
analyzing the image data with a processing system; and
adapting wireless communications with a wireless device based on the analyzed image data.

2. The method of claim 1, wherein adapting the wireless communications with the wireless device comprises initiating wireless communications with the wireless device using the image data.

3. The method of claim 1, wherein adapting the wireless communications with the wireless device comprises beamforming the wireless communications with the wireless device based on the analyzed image data.

4. The method of claim 1, wherein adapting the wireless communications with the wireless device comprises adjusting an allocation of network resources based on the analyzed image data.

5. The method of claim 1, further comprising processing the image data with the processing system to track a location of the wireless device in the environment.

6. The method of claim 5, wherein adapting the wireless communications with the wireless device comprises beam selecting one or more beamforming vectors for the wireless communications based on the tracked location of the wireless device in the environment.

7. The method of claim 5, wherein adapting the wireless communications with the wireless device comprises predicting a link blockage with the wireless device based on the tracked location of the wireless device in the environment.

8. The method of claim 7, wherein predicting the link blockage is further based on a predicted location of an object in the environment relative to the tracked location of the wireless device using the image data.

9. The method of claim 7, wherein adapting the wireless communications with the wireless device further comprises handing off the wireless communications to at least one of a different transceiver or a different network node.

10. The method of claim 7, wherein adapting the wireless communications with the wireless device further comprises changing a wireless channel for the wireless communications to avoid the link blockage.

11. The method of claim 7, wherein adapting the wireless communications with the wireless device further comprises buffering the wireless communications to mitigate the link blockage.

12. The method of claim 1, further comprising:
receiving additional environmental data of the environment; and
adapting the wireless communications with the wireless device further based on the additional environmental data.

13. The method of claim 12, wherein the additional environmental data comprises at least one of global positioning system (GPS) data received from the wireless device, light detection and ranging (LIDAR) data received from a LIDAR device, radar data received from a radar system, and a wireless signal received at a transceiver.

14. The method of claim 1, wherein receiving the image data comprises receiving image data from a plurality of imaging devices distributed in the environment.

15. A network node, comprising:
communication circuitry configured to establish communications with a wireless device in an environment; and
a processing system configured to:
receive image data of the environment;
perform an analysis of the environment in the image data; and
adapt communications with the wireless device in accordance with the analysis of the environment.

16. The network node of claim 15, wherein the communication circuitry comprises a multi-band radio transceiver.

17. The network node of claim 16, wherein the multi-band radio transceiver is configured to communicate via at least one sub-6 gigahertz (GHz) band and one millimeter wave (mmWave) band.

18. The network node of claim 16, wherein the multi-band radio transceiver is configured to communicate via at least one terahertz (THz) band.

19. The network node of claim 15, wherein the processing system is configured to perform the analysis of the environment using a machine learning framework to identify one or more potential blockages in the environment.

20. The network node of claim 19, wherein the machine learning framework comprises:
a first neural network configured to detect relevant objects in the environment; and
a second neural network configured to identify the one or more potential blockages in the environment.

21. The network node of claim 15, wherein the image data is received from the wireless device.

22. The network node of claim 15, further comprising a red-green-blue (RGB) camera configured to capture the image data.

23. A vision-aided wireless communications network, comprising:
transceiver circuitry;
an imaging device; and
a processing system configured to:
cause the transceiver to communicate with a wireless device;
receive image data from the imaging device;
process and analyze the image data to determine an environmental condition of the wireless device; and
adjust communications with the wireless device in accordance with the environmental condition of the wireless device.
